(19) United States
(12) Patent Application Publication
(10) Pub. No.: US 2008/0037971 A1
(43) Pub. Date: Feb. 14, 2008

(54) REMOTE-CONTROL DEVICE FOR CAMERA

(75) Inventors: Satoshi TAKAMI, Saitama (JP); Hiroshi ORITA, Saitama (JP); Naoki MURATA, Tochigi (JP); Fumie OSAKI, Saitama (JP); Hitoshi ENDA, Kanagawa (JP); Chie SUZUKI, Saitama (JP); Hidetoshi MIYAZAKI, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/738,613

(22) Filed: Apr. 23, 2007

(30) Foreign Application Priority Data
Apr. 24, 2006 (JP) 2006-119690

(51) Int. Cl. G03B 17/00

(52) U.S. Cl. 396/56

(57) ABSTRACT

A remote-control device, according to the present invention, is for a camera having a light signal receiver that receives a light signal. The remote-control device includes a light signal transmitter, a position adjuster, and a switch member. The light signal transmitter transmits the light signal. The position adjuster adjusts the relative position of the light signal transmitter with respect to the camera. The switch member is connected to the light signal transmitter and commands the light signal transmitter to transmit the light signal. The switch member is movable with respect to the light signal transmitter, and the position adjuster adjusts the relative position of the light signal transmitter so that the light signal is received by the light signal receiver.

### BACKGROUND OF THE INVENTION

1. Field of the Invention

The present invention relates to remote-control devices, especially to those that are used for commanding cameras to take a photograph and so on.

2. Description of the Related Art

Cameras which can take a photograph by an operation of remote-control devices are known. Such a remote-control device is primarily used by a user for taking a photograph of himself. Therefore, a light receiver which receives an infrared ray or other light transmitted from a remote-control device hold by a user, is provided at the front surface of a camera (the photographing lens side) on which a photographing optical system is provided.

Switches which can be operated with a limited exertion of force, for handicapped persons who cannot apply a force necessary to manually operate conventional switches due to physical handicaps, are known (hereinafter, such a switch is referred to as a welfare switch). A welfare switch, for example, is one which has a wide area to be depressed and which can be operated with very small force, or one which can be operated by an exhalation of a user. A user who cannot operate a conventional switch manually, tends to desire to carry out operations of a camera.

When an image is photographed by using a remote-control device. a user cannot confirm whether a subject image is displayed on a monitor provided on the rear side surface of a camera, because the light receiver is provided on the front side of the camera. Therefore, although remote control of the camera is possible, operationality for photographing a subject and other operations are not necessarily good.

To a user who can not easily operate a conventional switch and who usually uses a welfare switch or the like, it is also difficult to operate a conventional remote control device for photographing a subject, or other operations.

### SUMMARY OF THE INVENTION

Therefore, an objective of the present invention is to provide a remote-control device for a camera, which contributes to the improvement of the operationality of a camera, and which is compatible with various types of switches.

A remote-control device, according to the present invention, is for a camera having a light signal receiver that receives a light signal. The remote-control device includes a light signal transmitter, a position adjuster, and a switch member. The light signal transmitter transmits the light signal The position adjuster adjusts the relative position of the light signal transmitter with respect to the camera. The switch member is connected to the light signal transmitter and commands the light signal transmitter to transmit the light signal. The switch member is movable with respect to the light signal transmitter, and the position adjuster adjusts the relative position of the light signal transmitter so that the light signal is received by the light signal receiver.

BRIEF DESCRIPTION OF THE DRAWINGS

The present invention will be better understood from the description of the preferred embodiment of the invention set forth below, together with the accompanying drawings, in which:

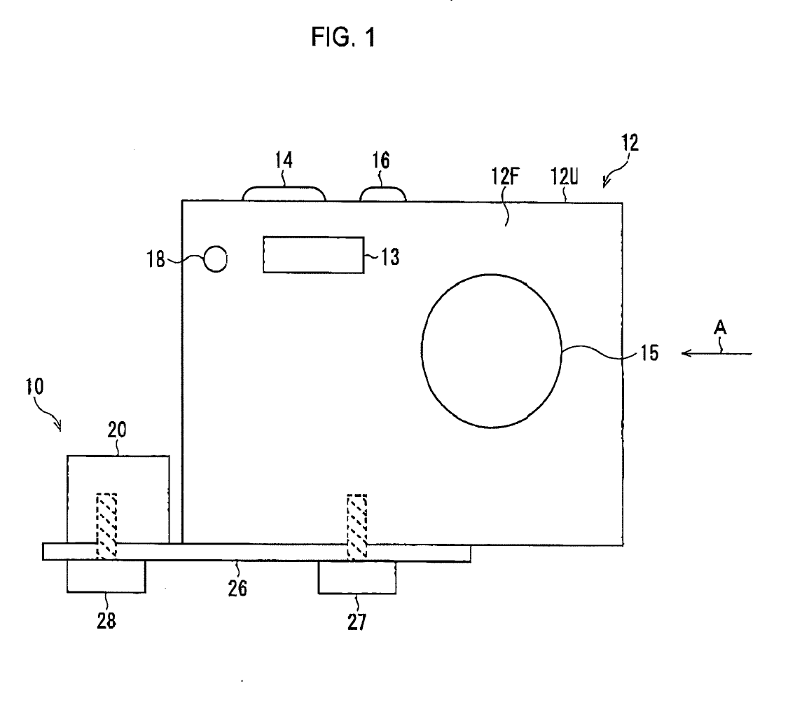

FIG. 1 is a front view of a remote-control device of the first embodiment;

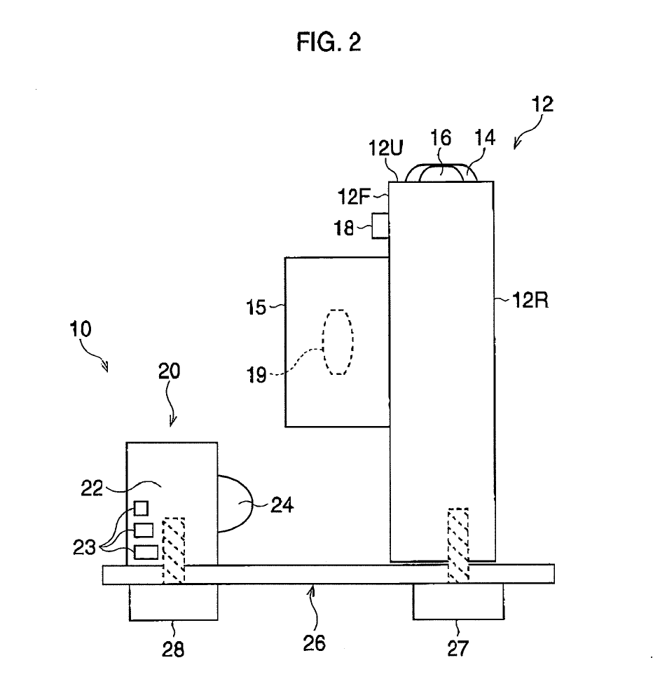

FIG. 2 is a side view of the remote-control device of the first embodiment as seen from the direction represented by the arrow A in FIG. 1;

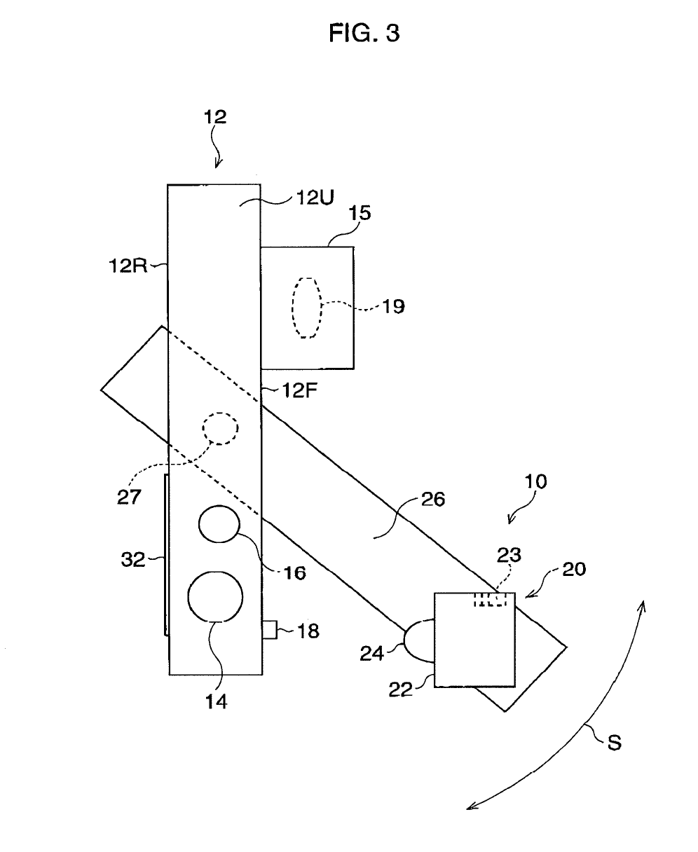

FIG. 3 is a plan view of a remote-control device of the first embodiment;

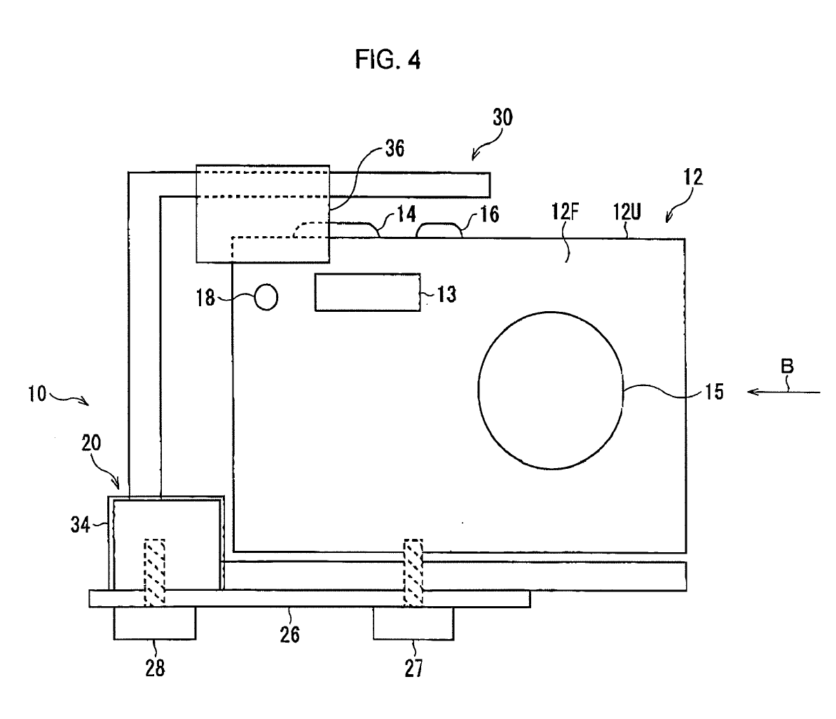

FIG. 4 is a front view of a remote-control device of the second embodiment;

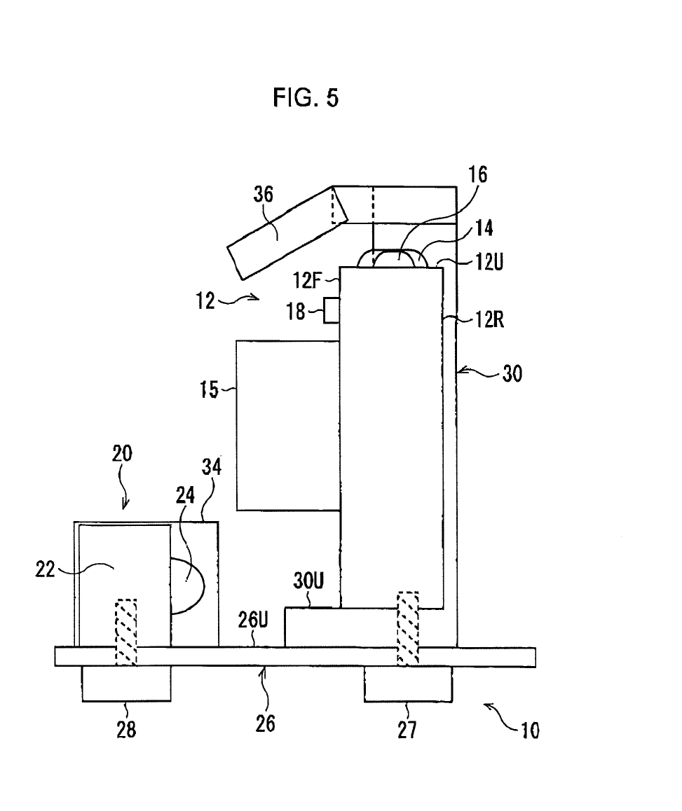

FIG. 5 is a side view of the remote-control device of the second embodiment as seen from the direction represented by the arrow B in FIG. 4;

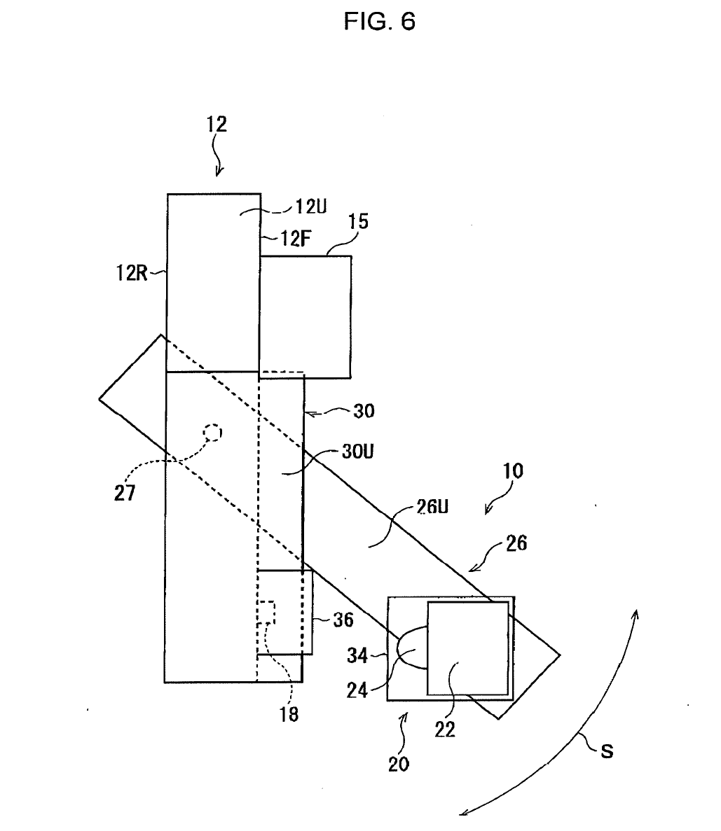

FIG. 6 is a plan view of a remote-control device of the second embodiment;

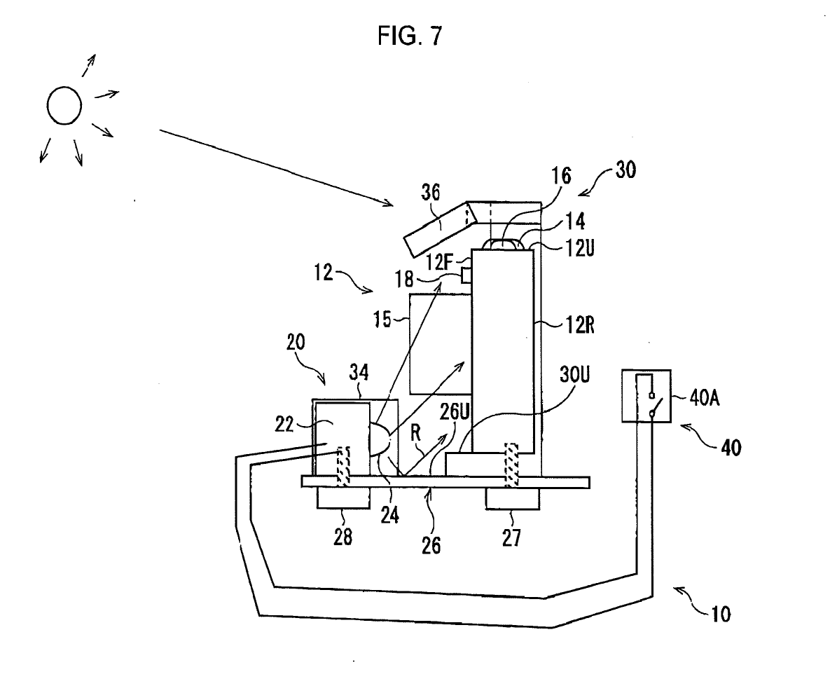

FIG. 7 is a simplified view of the remote-control device in use;

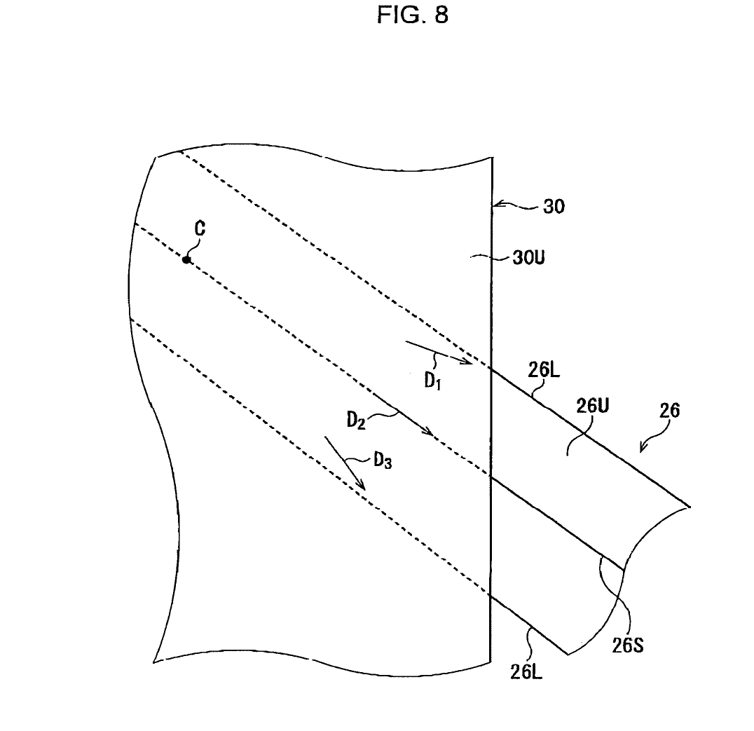

FIG. 8 is a simplified and magnified view of a part of a holding plate and a camera fastening device;

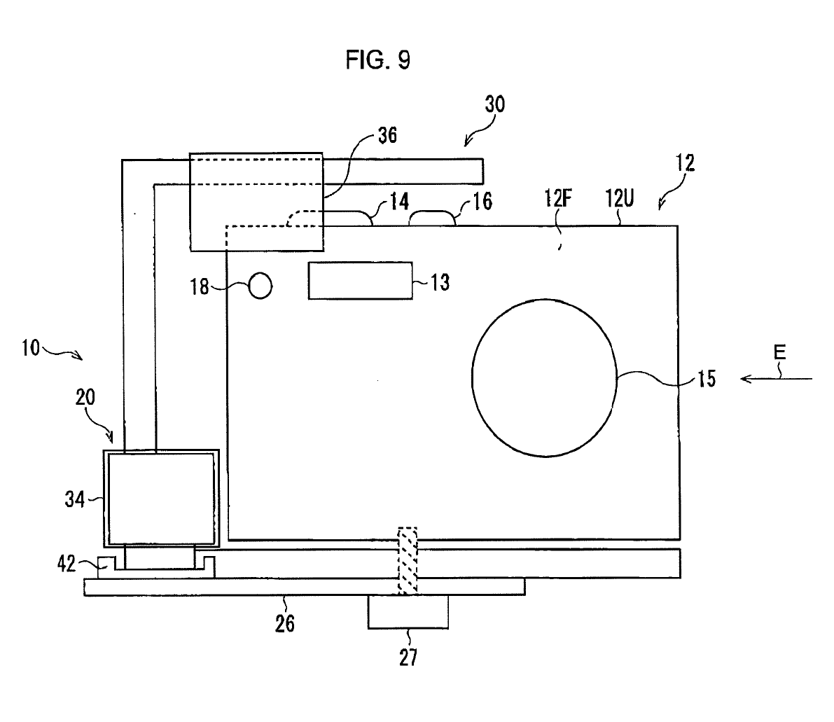

FIG. 9 is a front view of a remote-control device of the third embodiment; and

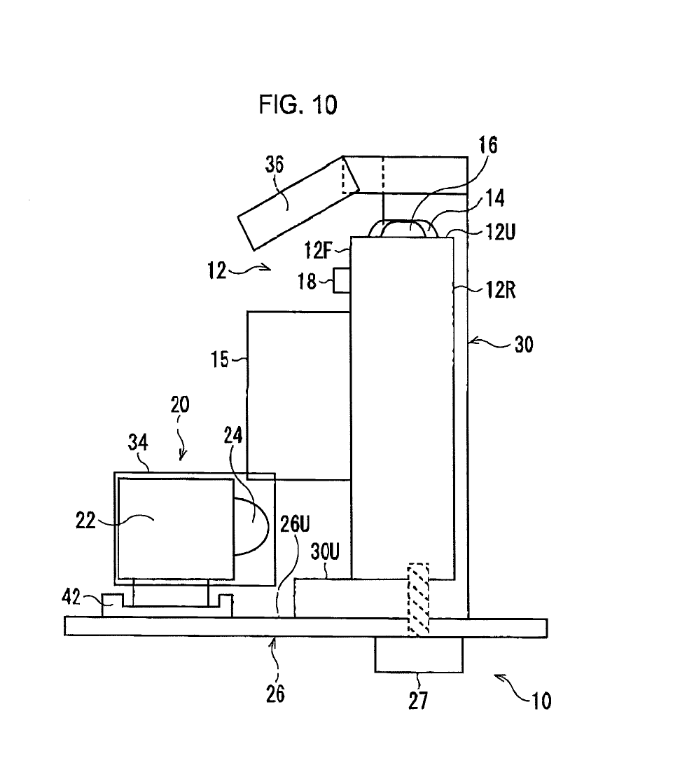

FIG. 10 is a side view of the remote-control device of the third embodiment as seen from the direction represented by the arrow E in FIG. 9.

### DESCRIPTION OF THE PREFERRED EMBODIMENTS

Hereinafter, the embodiments of the present invention are described with reference to the attached drawings.

The remote-control device 10 has a function to command the digital camera 12 (camera) to photograph a subject, to adjust zoom, etc., in addition to other functions that can be added as explained below, in the remote-control device 10, a transmitter 20 (a light signal transmitter) that transmits an infrared ray corresponding to the above mentioned functions as a light signal, is provided. The transmitter 20 includes a body 22 and a light-transmitting end 24 that transmits an infrared ray (see FIG. 2).

To the transmitter 20, a command switch (not shown) for commanding the light-transmitting end 24 to transmit an infrared ray is connected, so that the light-transmitting end 24 transmits an infrared ray, that is a light signal, due to the operation of the command switch. In the remote-control device 10, the command switch is independent of the transmitter 20 and movably connected to the transmitter 20. In this respect, the remote-control device 10 is unique to conventional remote-control devices in which a command switch and a transmitter are formed as one body.

On the front surface 12F of the digital camera 12, a receiving sensor 18 (a light signal receiver), a flash window 13, a photographing optical system 15 including a zoom lens 19 are provided. On the upper surface 12U of the digital camera 12, a release button 14, a power switch 16 for switching the power source of the digital camera 12 on and off state, are provided.

The digital camera 12 is fixed in the predetermined position on a tripod (not shown). The remote-control device 10 includes a holding plate 26 (a position adjuster) that holds the transmitter 20 and makes the adjustment of the relative position of the transmitter 20 with respect to the digital camera 12 possible. Near both ends of the holding plate 26, holes are provided in which first and second fixing screws 27, 28 are inserted.

One end of the holding plate 26 is fastened to the digital camera 12 by the first fixing screw 27. The first fixing screw 27 is a rotating screw, and the holding plate 26 is rotatable about the axis as indicated by the arrow 3 (see FIG.3). The other end of the holding plate 26 is fastened to the transmitter 20 by the second fixing screw 28. As evidenced by the matters mentioned above, the direction of the light-transmitting end 24 of the transmitter 20 is adjustable and corresponds to the rotational position of the holding plate 26, so that the receiving sensor 18 effectively receives an infrared ray from the transmitter 20. Note that a hole (not shown) in which the second fixing screw 28 is inserted and which is provided in the holding plate 26, extends in a longitudinal direction of the holding plate 26. Therefore, the distance of the second fixing screw 26 from the first fixing screw 27 is adjustable.

On the rear surface 12R of the digital camera 12, an LCD monitor 32 (an image display, see FIG. 3) for displaying a subject image to be photographed, and so on, is provided. As mentioned above, although the receiving sensor 18 and the LCD monitor 32 are provided on different surfaces of the digital camera 12, remote control can be carried out because the command switch can be set apart from the transmitter 20. Further, because the position and direction of the transmitter 20 can be adjusted, a user can see and confirm a subject image on the monitor 32 from the rear surface 12R side of the digital camera 12, while operating the command switch and commanding the digital camera 12 to take a photograph or so on, via the transmitter 20. This feature is in contrast to conventional remote-control devices, by which command for photographing a subject and so on is possible only from the front surface 12F side of the digital camera 12, on which the receiving sensor 18 is provided. The present invention makes it possible to command photographing and so on while watching the rear surface 12R of the digital camera 12 without touching the release button Id or the power switch 16. Therefore, by using the remote-control device 10, improvements in the efficiency of photographing become possible.

In the body 22, connection holes 23 in which connecters of command switches are detachably attached, are provided. By modifying the shapes of the connection holes 23 and the internal structure of the body 22 of the transmitter 20, various different types of connecters of command switches can be attached in one of the connection holes 23. Therefore, in this embodiment, a plurality o±command switches different from one another can be selectively used.

Specifically, a welfare switch, used for a user who experiences difficulty applying a force required to operate a conventional switch due to a physical handicap or the like, can be used with the transmitter 20. The welfare switches include one which has a wide area to be depressed and that can be operated with a very small force one which can be operated by an exhalation of a user, one which is operated by a motor, and so on. Therefore, the remote-control device of the first embodiment can be easily operated by a user who experiences difficulty when operating a conventional switch.

As explained above, the remote-control device 10 can improve the operationality of the digital camera 12, because a user can confirm a subject displayed on the monitor 32 while he or she is using the remote-control device 10. Further, various different types of welfare switches can be used with the remote-control device 10, so that the remote-control device 10 can be easily operated by a user who experiences difficulty when using a conventional switch.

Note that the commands available for uses with the remote-control device 10 are not limited Lo photographing a subject or adjusting the zoom; emitting a flash of light from the flash window 13, switching the power source, and so on may also be commanded by the remote-control device 10. Further, command for a zoom adjustment may be carried out, for example, by selecting a desirable focal distance from those previously set in accordance with the number of the operation of the command switch.

Next, the second embodiment, and primarily the differences between it and the first embodiment, are explained. In the second embodiment, as explained below, a member which increases the effectiveness of the ability of the receiving sensor 18 to receive an infrared ray transmitted from the light-transmitting end 24 is provided in the remote-control device 10, which is different from the first embodiment.

In the transmitter 20, a housing 34 enclosing the transmitter 20 is provided (see FIG. 4). The light-transmitting end 24 and the housing 34 are made from transparent resin, so that an infrared ray transmitted from the light-transmitting end 24 is initially diffused by the light-transmitting end 24 itself, and further diffused as it passes through the front side of the housing 34 enclosing the light-transmitting end 24. Thus, the housing 34 not only protects the transmitter 20, but also improves the ability of the receiving sensor 18 to sufficiently receive an infrared ray having high directivity. Note that a diffusing plate may be provided in front of the light-transmitting end 24, instead of providing the light-transmitting end 24 and housing 34 with diffusion characteristics.

Note that in the remote-control device 10 of the second embodiment, a camera fastening device 30 to enhance the digital camera 12 is included, in the camera fastening device 30, a light intercepting plate 36 (a light interceptor) to intercept sunlight and other light from external sources is provided at the upper side of the receiving sensor 18. Due to the light intercepting plate 36, a bright external light is prevented from entering the receiving sensor 18 and causing a detection error by interfering with or taking the place of a light signal from the transmitter 20 (see FIG. 7) in an outdoor photograph. Therefore, the command of the light signal of an infrared ray is sufficiently transmitted to the digital camera 12 even in the presence of another infrared ray, including sunlight.

The upper surface 26U of the holding plate 26 (see FIGS. 5 to 7) is coated with a paint that reflects infrared rays. Therefore, a portion of the infrared rays emitted from the light-transmitting end 24, due to the operation of an operation member 40A of the command switch 40, and diffused by the housing 34, is reflected upwards by the upper surface 26U of the holding plate 26 where it makes contact with the receiving sensor 18, as indicated by the arrow R. As a result, the receiving sensor 18 can also receive a component of the diffused infrared ray that was originally diffused to travel downward. Note that the operation member 40A is movably connected to the transmitter 20.

To increase the effect of reflecting the infrared ray on the holding plate upper surface 26U, the area of the holding plate upper surface 26U may be expanded, for example by enlarging the width of the holding plate 26 without providing a negative effect on the operationality of the remote-control device 10. Further, to obtain such an effect, the light receiving area of the receiving sensor 18, that receives the infrared ray from the transmitter 20, may also be expanded.

To ensure that the infrared ray is receivable by the receiving sensor 18, an arrangement of the transmitter 20 in front of the digital camera 12 to face the receiving sensor 18 is preferable. In such a configuration, the transmitter 20 should be out of the photographing area of the photographing system 15 of the digital camera 12, and not be included in a subject image.

Therefore, on an area of the upper surface 30U of the camera fastening device 30, which extends from the front surface 12F side of the digital camera 12, three marks are provided, the first, second and third marks D1, D2 and D3 (see FIG. 8) that represent the inclined angles of the holding plate 26 against the front surface 12F of the digital camera 12. Near the first to third marks D1 to D3, numbers for indicating the inclined angles (not shown) are marked, and marks representing the inclined angles other than those represented by the first to third marks D1 to D3 are also provided on the upper surface 30U of the camera fastening device 30.

On the other hand, on the upper surface 26U of the holding plate 26 that rotates around the point C, a center line 26S parallel to the long sides 26L of the outline of the holding plate 26 is provided so that a user can easily confirm the inclined angle by visually checking to determine whether or not the center line 26S is coincident with one of the marks including the first to third marks D1 to D3, or checking to see where the center line 26S is with respect to the two closest marks. In a situation where the second mark D2 and the center line 26S are coincident with each other, for example, the angle formed by the holding plate 26 and the front surface 12F of the digital camera 12 is 45 degrees.

Because the transmitter 20 is always held in the predetermined position on the holding plate 26, the position of the transmitter 20 with respect to the digital camera 12 corresponds to the inclined angle. Therefore, the minimum inclined angle required for the transmitter 20 to be out of the photographing area, based on the focal distance of the photographing optical system 15 and the range of the incident angle where light can enter the zoom lens 19 of the photographing optical system 15, can be confirmed beforehand. Therefore, the transmitter 20 can be promptly moved to a position suitable for emitting the infrared ray, while remaining outside of the photographing area. The numbers representing the inclined angle and so on may also be provided on the upper surface 26U of the holding plate 26, in addition to the upper surface 30U of the camera fastening device 30. Printing letters or marks on the upper surface 26U of the holding plate 26 will not impact negatively on the light reflection ratio of the whole upper surface 26U of the holding plate 26.

As explained above in the second embodiment, enabling the receiving sensor 18 to receive the light signals and moving the transmitter 20 to a suitable position for its operation, are both possible.

Next, the third embodiment, primarily the differences between it and the second embodiment, are explained. In the third embodiment, the transmitter 20 is fixed to the holding plate 26 by using a camera hot shoe 42 instead of the second fixing screw 28, in contrast to the second embodiment. In the third embodiment, by using such a general-purpose accessory part, the remote-control device 10 can be easily manufactured.

Further, installing the transmitter 20 to the camera hot shoe 42 is an easier operation than installation with the second fixing screw 28. Although the installation direction of the camera hot shoe 42 cannot be adjusted, the holding plate 26 can be installed so that the transmitter 20 and the receiving sensor 18 face each other (not shown). Further, in a case where the transmitter 20 and the receiving sensor 18 are arranged facing away from each other, light signals can be received from a wide range by the receiving sensor 18, by providing the light-transmitting end 24 with a light diffusing effect, or by placing a material with light diffusing effects in front Of the transmitter 20. Further, the holding plate 26 and other members are provided so that the distance between the transmitter go and the receiving sensor 18 is short, thus enabling the intensity of the light signals to be maintained at a sufficient level to enable the transmittance thereof, despite having been diffused.

The shapes of the members in the remote-control device 10, such as the transmitter 20, holding plate 26, and the camera fastening device 30, are not limited to those represented in the above embodiments. Further, the subject of use of the remote-control device 10, is not limited to the digital camera 12, as far as the light signals for remote control can be received.

This invention is not limited to that described in the preferred embodiment, namely, various improvements and changes may be made to the present invention without departing from the spirit and scope thereof.

The present disclosure relates to subject matter contained in Japanese Patent Application No. 2006-119690 (filed on Apr. 24, 2006), which is expressly incorporated herein, by reference, in its entirety.

1. A remote-control device for a camera having a light signal receiver that receives a light signal, said remote-control device comprising:
a light signal transmitter that transmits said light signal;
a position adjuster that adjusts the relative position of said light signal transmitter with respect to said camera; and
a switch member that is connected to said light signal transmitter and that commands said light signal transmitter to transmit said light signal; said switch member being movable with respect to said light signal transmitter, said position adjuster adjusting the relative position of said light signal transmitter so that said light signal is received by said light signal receiver.

2. The remote-control device according to claim 1, wherein a plurality of said switch member can be selectively connected to said light signal transmitter.

3. The remote-control device according to claim 1, wherein said camera further comprises an image display that displays a subject image to be photographed, said light signal receiver and said image display being provided on different surfaces of said camera.

4. The remote-control device according to claim 1, wherein a surface of said position adjuster reflects said light signal.

5. The remote-control device according to claim 1, further comprising a light diffuser that diffuses said light signal.

6. The remote-control device according to claim 5, wherein said light diffuser is a light-transmitting end of said light signal transmitter.

7. The remote-control device according to claim 1, further comprising a light interceptor that intercepts light other than said light signal to enter said light signal receiver.

8. The remote-control device according to claim 7, further comprising a camera fastener that fastens said camera, said camera fastener comprising said light interceptor.

9. The remote-control device according to claim 1, wherein said position adjuster holds said light signal transmitter while making the adjustment of the relative position of said light signal transmitter with respect to said camera possible.

10. The remote-control device according to claim 9, further comprising a camera fastener that fastens said camera, a mark representing the position of said light signal transmitter is on said camera fastener.

11. The remote-control device according to claim 1, wherein said camera further comprises a zoom lens for photographing a subject, and said light signal commanding at least one of either photographing said subject or adjusting said zoom position of said zoom lens.
